(19) United States
(12) Patent Application Publication
(10) Pub. No.: US 2017/0304792 A1
(43) Pub. Date: Oct. 26, 2017

(54) DEVICE FOR SYNTHESISING AND STUDYING COMPOUNDS UNDER CONTROLLED TEMPERATURES AND PRESSURES

(71) Applicants: UNIVERSITE DE NANTES, NANTES (FR); CENTRE NATIONAL DE LA RECHERCHE SCIENTIFIQUE (CNRS), Paris (FR)

(72) Inventors: Erwan LE MENN, GRANDCHAMP DES FONTAINES (FR); Adriana OANCEA, MARCQ EN BAROEUL (FR); Gabriel TOBIE, NANTES (FR); Olivier GRASSET, SAINT ETIENNE DE MONTLUC (FR)

(73) Assignees: UNIVERSITE DE NANTES, NANTES (FR); CENTRE NATIONAL DE LA RECHERCHE SCIENTIFIQUE (CNRS ), Paris (FR)

(21) Appl. No.: 15/528,587

(22) PCT Filed: Nov. 30, 2015
(86) PCT No.: PCT/EP2015/078031

§ 371 Date: Jun. 19, 2017

(30) Foreign Application Priority Data
Dec. 4, 2014 (FR) 14/61933

(51) Int. Cl. B01J 3/00; B01J 3/03; B01J 3/02; G01N 37/00

(52) U.S. Cl. CPC B01J 3/006; G01N 37/00; B01J 3/004; B01J 3/02; B01J 3/03

(57) ABSTRACT

A device for synthesising and studying compounds under controlled temperatures and pressures includes: a body delimiting a vacuum chamber including temperature-regulation means and vacuum-application means, and having one or more viewing windows enabling the inside of the chamber to be observed from the outside; temperature-regulation means that are intended for regulating the temperature inside the vacuum chamber; and vacuum-application means that are intended for regulating the pressure in the vacuum chamber; wherein it includes, inside the vacuum chamber, a sealed structure delimiting a sealed chamber having one or more viewing window facing said one or more windows in said body, and at least one pipe that is in fluid communication firstly with the inside of said sealed chamber and secondly with an outlet that is made in the body and provided in order to be connected to one or more sources of gas for synthesising said compound or sample.

The present invention relates to a device for synthesising and studying compounds under controlled temperatures and pressures. Such a device makes it possible to carry out syntheses and studies of various chemical or biological compounds over a wide range of temperature and pressure, between 80K and 450K and up to 20 bar.

Such a device makes it possible, for example, to synthesise and analyse gas hydrates, also referred to as gas clathrates.

Gas hydrates are crystalline structures, referred to as clathrate structures, in which the water molecules form units assembled together repetitively and define cavities able to trap gaseous host molecules. Such compounds are found in particular in the ices of ice satellites in the solar system, on the earth in polar regions, in frozen soil and the pole caps, as well as in sea beds on some continental slopes. Because of their ability to store and transport gases, studies thereof are of particular interest. These gas hydrates form and remain stable either under high pressure at ambient temperature, or at low temperature under ambient pressure. Their stability also depends greatly on the composition of the gas trapped in the cages. Studying the stability of such crystalline structures under pressure/temperature, on a microscopic scale, is essential for understanding the processes of chemical exchanges in waster-rich environments.

Currently, synthesising these compounds and studying them requires the use of several separate devices. This involves a transfer of the sample between the synthesis device and the analysis device, giving rise to a destabilisation of the sample, which is temporarily situated outside its stability field. This same type of problem can be encountered with other chemical and biological compounds requiring a very precise stability range.

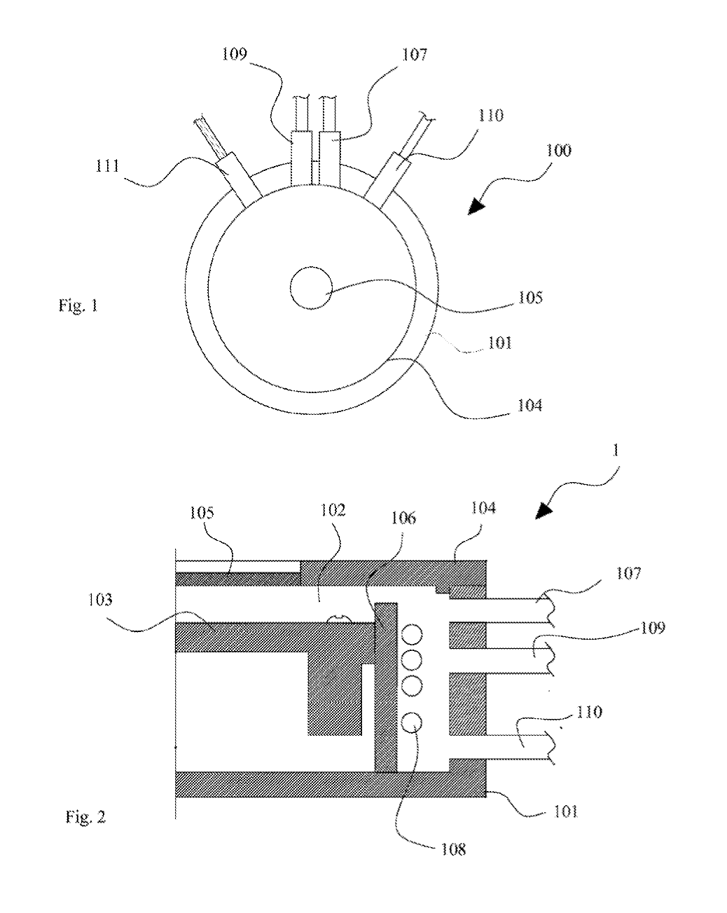

A device generally used in such a method for analysing clathrate compounds is shown in relation to FIGS. 1 and 2. This device 100 is in the form of a cylindrically shaped body 101 delimiting a vacuum chamber 102 provided with a receptacle 103 at its centre for placing the sample or compound to be analysed. The body is closed by a cover 104 that is provided with a viewing window 105, for example a sapphire window, allowing observation and analysis of the sample on the support by microscopy and spectroscopy techniques. Annular heating means 106 are disposed around the receptacle 103. The vacuum chamber 102 contains a coil 108 that is in communication with an inlet 107 for a cooling gas, such as liquid nitrogen, and an outlet 109 for this cooling gas. The cooling gas is able to flow in the coil 108 in an annular flow in the vacuum chamber 102. The vacuum chamber 102 is in communication with a vacuum pump 110. An access 111 to electrical means is also provided. The purpose of putting under vacuum is to insulate the sample thermally by eliminating heat exchanges by convection between the receptacle 103 and the external casing of the cryostat. However, the sample, being in contact with the vacuum, may, depending on the host molecule, be destabilised, giving rise to a loss of gas.

One aim of the present invention is to propose a device allowing both the synthesis and study of chemical and biological compounds under controlled temperatures and pressures. In particular, the purpose of a device according to the invention is to allow synthesis of said samples and analyses thereof in the same chamber or device, and thus eliminating any manipulation and transfer of said synthesised sample or compound outside its temperature and pressure ranges and therefore stability range.

To this end, the invention relates to a device for synthesising and studying compounds under controlled temperatures and pressures, comprising:

a body delimiting a vacuum chamber and having one or more windows for observing inside the chamber from the outside,

temperature-regulation means intended to regulate the temperature inside the vacuum chamber, and

vacuum-application means intended to regulate the pressure in the vacuum chamber,

which is characterised in that it comprises, inside the vacuum chamber, a sealed structure delimiting a sealed chamber having one or more viewing windows facing one or more windows of said body, and at least one pipe that is in fluid communication firstly with the inside of said sealed chamber and secondly with an outlet that is made in the body, and is provided in order to be connected to one or more sources of gas for synthesising said compound.

The device according to the invention comprises a sealed chamber in which the subsequent synthesis and analysis of a biological or chemical compound or sample take place. The addition of the gas or gases for synthesising the compound in the sealed chamber is done by means of a pipe connected to the synthesis-gas source, the pipe emerging directly inside the sealed chamber. The sealed chamber makes it possible to isolate the synthesised compound from the vacuum chamber, which avoids causing phenomena of loss of stability of the compound. Likewise, since the study takes place directly in the sealed chamber, the destabilising step of the transfer, in the cold chamber, from the autoclave to any study and analysis device is eliminated. The device according to the invention therefore makes it possible to keep the synthesised compound or sample in its temperature and pressure stability range. The pipe connected to an external gas source also makes it possible to vary the pressure in the sealed chamber in order, for example, to carry out stability studies on the compound according to the pressure. The sealed chamber is in fact able to be put under a pressure of up to 200 bar. Likewise, the means for regulating the temperature make it possible to vary the temperature for stability studies over a given range.

According to one embodiment of the invention, the sealed structure consists of a top portion and a bottom portion connected together by connection means.

Advantageously, the connection means are removable.

This embodiment makes it possible to dismantle the sealed chamber for cleaning thereof or any other manipulation.

According to one embodiment, the body has two viewing windows facing each other, the top portion of said sealed structure has a viewing window facing a viewing window in said body, the bottom portion of said sealed structure has a viewing window facing the other viewing window in said body as well as a viewing window in the top portion.

This embodiment allows analysis of the synthesised sample or compound by transmission microscopy.

According to one embodiment of the invention, the top portion of said sealed structure has a viewing window facing a window that the body has, the bottom portion of said sealed structure not having a viewing window.

This embodiment allows analysis of the synthesised sample and compound by reflection microscopy.

Advantageously, a gasket is disposed between the top and bottom portions.

According to another embodiment of the invention, the device in addition comprises a second pipe for putting the sealed chamber under vacuum, said pipe being in fluid communication firstly with the inside of said sealed chamber and secondly with an outlet that is formed in the body and is provided for being connected to a device for applying a vacuum.

According to one embodiment of the invention, either the bottom portion or the top portion of said sealed structure has at least one machining through which a pipe extends.

Advantageously, each pipe is a capillary tube, at least the part of which that extends in the bottom portion or the top portion of said sealed structure is covered with a stainless-steel tube.

The invention also relates to a sealed structure designed to be disposed inside a device for synthesising and studying compounds under controlled temperatures and pressures as described previously, said sealed structure delimiting a sealed chamber having one or more viewing windows facing each other, and at least one pipe that is in fluid communication firstly with the inside of said sealed chamber and secondly with an outlet leading out of said sealed structure.

Advantageously, the sealed structure has the features previously mentioned in relation to the device according to the invention.

The features of the invention mentioned above, as well as others, will emerge more clearly from a reading of the following description of an example embodiment, said description being given in relation to the accompanying drawings, among which:

FIG. 1 is a plan view of a device for studying chemical compounds according to the prior art,

FIG. 2 is a half-section along an axial plane of the device for studying chemical compounds in FIG. 1,

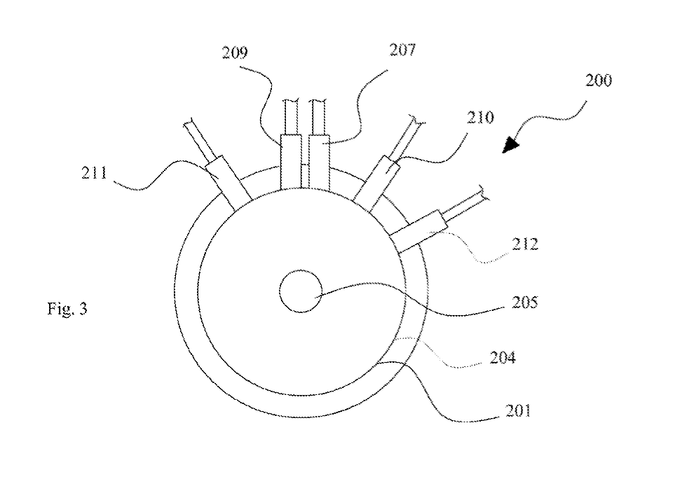

FIG. 3 is a half-section along an axial plane of a device for synthesising and studying compounds under controlled temperatures and pressures according to an embodiment of the invention,

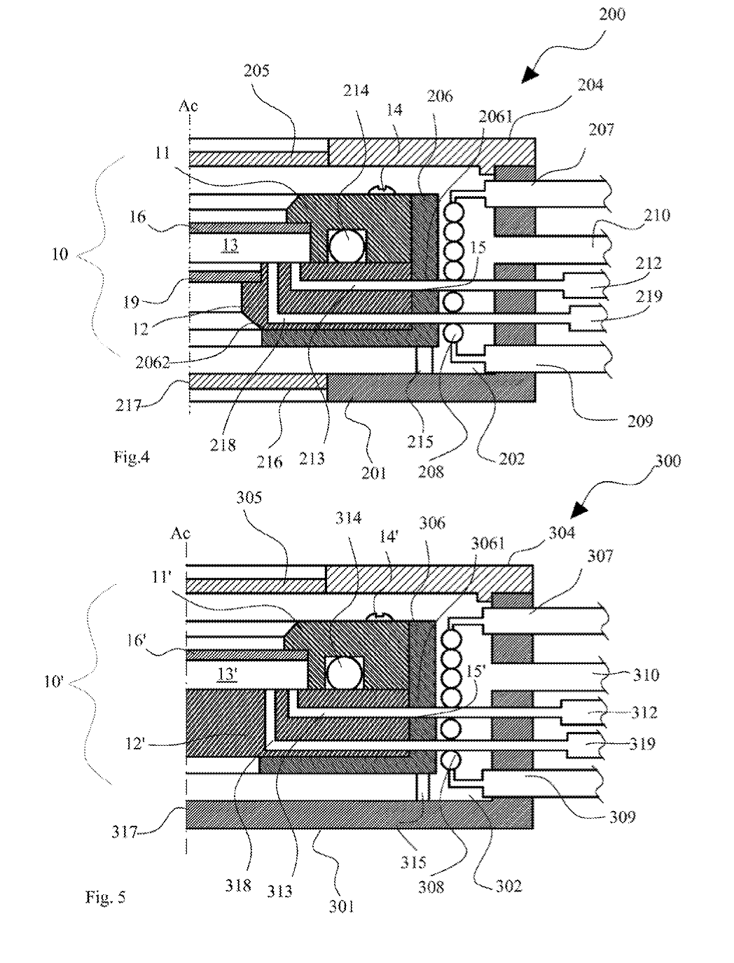

FIG. 4 is a half-section along an axial plane of a device for synthesising and studying compounds under controlled temperatures and pressures according to the first embodiment of the invention,

FIG. 5 is a half-section along an axial plane of a device for synthesising and studying compounds under controlled temperatures and pressures according to the second embodiment of the invention,

A device 200 for synthesising biological or chemical compounds, for example clathrate compounds, under controlled temperatures and pressures and allowing the subsequent analysis and study of this compound by a transmission microscopy technique is shown in relation to FIG. 3, which shows a plan view of the device 200, and in relation to FIG. 4, which shows a view in half-cross-section of the device 200. The device 200 is in a circular form when it is seen from above and below.

The device 200 comprises a body 201 that delimits a vacuum chamber 202 and has viewing windows 205, 216 facing each other. These windows make it possible to see inside the device 200, in particular with microscopy techniques.

The device 200 also comprises temperature-regulation means 206, 208 intended to regulate the temperature inside the vacuum chamber 202, as well as vacuum-application means 210 intended to regulate the pressure in the vacuum chamber 202.

Inside the vacuum chamber 202 is a sealed structure 10 delimiting a sealed chamber 13 having viewing windows 16, 19 facing each other and facing windows 205, 216 in the body 201, the windows 16, 19, 205 and 216 make it possible to observe inside the sealed chamber 13 from the outside of the device 200.

Inside the vacuum chamber 202 there is also a pipe 213 that is in fluid communication firstly with the inside of the sealed chamber 13 and secondly with an outlet 212 that is formed in the body 201 and is designed to be connected to one or more sources of gas for synthesising the compound to be synthesised.

The subsequent synthesis and analysis of a biological or chemical compound or sample take place inside the sealed chamber 13 of the sealed structure 10. The addition of the synthesis gas or gases of the compound in the sealed chamber 13 is done by means of the pipe 213 connected to the source of synthesis gases, the pipe 213 emerging directly in the internal space of the sealed chamber 13. For example, the gas sources necessary for synthesising clathrates are carbon dioxide, nitrogen and methane. The sealed chamber 13 makes it possible to isolate the synthesised compound from the vacuum chamber 202, which avoids causing phenomena of loss of stability of the compound Likewise, since the study takes place directly in the sealed chamber 13, no step of transferring from the device dedicated to synthesis to a device dedicated to analysis by microscopy technique is necessary. The synthesised compound or sample is kept in its temperature and pressure stability range. This is because the sealed chamber 13 makes it possible to work over a range of pressures between 10⁻³ mbar and 150 bar and over a temperature range of between 80K and 450K±0.1K. The temperature may vary in the chamber 13 by virtue of the temperature-regulation means. The pressure may vary in the chamber 13 by means of the gas source allowing an entry of gas into the chamber 13 through the pipe 213. For example, when clathrate compounds are synthesised, the pressure in the sealed chamber 13 is adjusted, by means of the pipe 213, to 150 bar and the temperature is regulated, by means of the temperature-regulation means, at 300K. During subsequent studies of the synthesised compound, the pressure and temperature may vary over the ranges indicated previously.

The body 201 is closed by a cover 204 in which the viewing window 205 is provided. The window 216, for its part, is provided in the base 217 of the body 201. The central axes of the windows 205 and 216 are merged and also merged with the central axis Ac of the device 200.

The means for regulating the temperature in the device 200 are composed of an annular heating means 206 that is disposed at the centre of the vacuum chamber 202 and is fixed to the base 217 of the body 201 by means of pillars 215. The annular heating means 206 extends all around the sealed structure 10. It has means for supporting the sealed structure 10. In this embodiment, it has a planar surface 2062 on which the sealed structure 10 rests.

The temperature-regulation means also comprise a coil 208 that emerges outside the body 201 through an inlet 207 and an outlet 209 to enable a cooling gas, such as liquid nitrogen, to flow in the coil 208, by means for example of a pump (not shown). The inlet 207 and the outlet 209 may take the form of channels.

Finally, the temperature-regulation means comprise a temperature sensor, preferentially a plate-type resistance sensor (not shown).

The body 201 has a channel 210 passing through it, which emerges firstly in the vacuum chamber 202 and secondly outside the body 201, where it is connected to a vacuum pump in order to create the vacuum in the vacuum chamber 202.

An access 211 for electrical means is also provided (FIG. 3).

The sealed structure 10 and the body 201 have, in the embodiment described in FIGS. 3 and 4, a cylindrical shape. The central axis of the sealed structure 10 and the central axis of the body 201 are merged (Ac).

The sealed structure 10 is in the form of an assembly of a top portion 11 and a bottom portion 12 connected to each other by a connection means, for example a screw 14, around the sealed chamber 13. The connection means is removable in order to facilitate the mounting and demounting of the portions 11 and 12.

The top 11 and bottom 12 portions are parts produced from stainless steel. Prior to their mounting, they undergo thermal and chemical surface treatments, such as mechanical polishing by means of a quarter-micrometre diamond suspension, and then cleaned with ultrasound. The heat treatment of the parts takes place at 540° C. for 4 hours in accordance with the Aubert and Duval recommendations, then passivation of the parts for 5 minutes in accordance with ASTM 380. The passivation makes it possible to clean and eliminate the layers of oxide formed on the surface of the elements 11 and 12. The solution used to do this is a mixture of nitric acid, hydrofluoric acid and water. The parts are next rinsed and cleaned with ultrasound.

The top portion 11 of the sealed structure 10 has a viewing window 16 that is situated facing the viewing window 305 in the body 201. The bottom portion 12 also has a viewing window 19 that is situated facing the viewing window 216 in the body 201 and the viewing window 16 in the top portion 11. The central axes of the viewing windows 16, 19, 216 and 305 are merged (Ac). The viewing windows 16 and 19 make the device 200 suitable for studying compounds by transmission microscopy.

The viewing windows 16 and 19 are fixed by adhesive bonding in grooves respectively provided in the top 11 and bottom 12 portions.

The viewing windows 305, 216. 16 and 19 are, when the device 200 is dedicated to the synthesis and study of clathrate compounds, made from sapphire. They have a thickness of 1 mm and a useful diameter of 8 mm.

The sealing of the chamber 10 is provided by means of an O-ring seal 214 made from Teflon disposed between the top portion 11 and the bottom portion 12.

The pipe 213 is advantageously in the form of a capillary tube. A machining is formed in the bottom portion 12, between the inside of the sealed chamber 13 and an outlet 15 of the structure 10, so as to enable the pipe 213 to pass from an outlet 212 that is formed in the body 201 to the inside of the sealed chamber 13. The portion of the capillary tube that extends in the bottom portion 12 of the chamber 13 is covered with a stainless-steel structure such as a stainless-steel tube. The stainless-steel tube protects the capillary from phenomena of overheating and expansion that may be caused inside the capillary.

The heating means 206 that surrounds the sealed structure 10 naturally has passages 2061 such as jaws, for the pipe 213 to pass.

In relation to FIG. 5, a device 300 is shown, allowing the synthesis of biological or chemical compounds, for example clathrate compounds, under controlled temperatures and pressures and allowing the subsequent analysis and study of this compound by a reflection microscopy technique. The device 300 differs from the device 200 solely in that the bottom portion 12′ does not contain a viewing window. For the remainder, the device 300 contains features identical to those of the device 200 and has the same technical advantages.

In particular, the device 300 comprises a body 301 that delimits a vacuum chamber 302 and has a viewing window 305.

The device 300 further comprises temperature-regulation means 306, 308 intended to regulate the temperature inside the vacuum chamber 302, as well as vacuum-applying means 310 intended to regulate the pressure in the vacuum chamber 302.

Inside the vacuum chamber 302 there is a sealed structure 10′ delimiting a sealed chamber 13′ having a viewing window 16′ facing a window 305 in the body 301. The windows 16′ and 305 make it possible to observe inside the sealed chamber 13′ from the outside of the device 300.

Inside the vacuum chamber 302 there is also a pipe 313 that is in fluid communication firstly with the inside of the sealed chamber 13′ and secondly with an outlet 312 that is formed in the body 301 and is designed to be connected to one or more sources of gas for synthesising the compound to be synthesised. The pipe 313 emerges out of the sealed structure 10′ through an outlet 15′.

The subsequent synthesis and analysis of a biological or chemical compound or sample take place inside the sealed chamber 10′ of the sealed structure 13′ as is the case with the device 200 described previously. The addition of the gas or gases for synthesising the compound in the sealed chamber 13′ is done by means of the pipe 313 connected to the synthesis-gas source, the pipe 313 emerging directly in the internal space of the sealed chamber 13′. In this embodiment also, the sealed chamber 13′ makes it possible to isolate the synthesised compound from the vacuum chamber 302. The synthesised compound or sample is kept in its temperature and pressure stability range. During subsequent studies of the synthesised compound, the pressure may vary over a range between 10⁻³ mbar and 150 bar and the temperature may vary over a range between 80K and 450K±0.1K.

As mentioned previously, the top portion 11′ of the sealed structure 10′ has a viewing window 16′ facing a window 305 that the cover 304 of the body 301 has, the bottom portion 12′ not having a viewing window Likewise, the base 317 of the body 301 does not have a viewing window. The device 300 is thus suited to a study by reflection microscopy technique.

The temperature-regulation means comprise a coil 308 that extends between an inlet 307 and an outlet 309 to enable a cooling gas, such as liquid nitrogen, to flow in the coil 308, an annular heating means 306 that is fixed to the base 317 of the body 301 by means of pillars 315. The annular heating means 306 extends all around the sealed structure 10′ and has a planar surface 2062 on which the sealed structure 10 rests.

The body 301 has a channel 310 passing through it, which emerges firstly in the vacuum chamber 302 and secondly outside the body 301, where it is connected to a vacuum pump in order to create the vacuum in the vacuum chamber 302.

The device 300 is, seen from above, identical to the device 200 shown in FIG. 3. It thus has a cylindrical structure.

The sealed structures 10 and 10′ can be dismantled and reassembled easily in synthesis and study devices 200 and 300 according to the invention.

Optionally, the device 200, 300 may comprise a second pipe 218, 318 advantageously in the form of a capillary tube, establishing a fluid communication between the inside of the sealed chamber 13. 13′ and an outlet 219, 319 that is formed in the body 201, 301 and is connected to a vacuum-applying device. The second capillary 218, 318 is used to establish a vacuum inside the chamber 13, 13′, for example, before this sealed chamber is pressurised. It is possible to provide a control means for checking that the vacuum is established. For example, the vacuum is established by the capillary 218, 318 and measured by the other capillary 213, 313.

1. A device for synthesising and studying compounds under controlled temperatures and pressures, comprising:
a body delimiting a vacuum chamber comprising temperature-regulation and vacuum-applying means, and having one or more viewing windows for observing inside the chamber from the outside,
temperature-regulation means intended to regulate the temperature inside the vacuum chamber, and
vacuum-application means intended to regulate the pressure in the vacuum chamber,
wherein inside the vacuum chamber, a sealed structure delimiting a sealed chamber having one or more viewing windows facing one or more windows of said body, and at least one pipe in fluid communication firstly with the inside of said sealed chamber and secondly with an outlet that is made in the body, and is provided in order to be connected to one or more sources of gas for synthesising said compound.

2. The device according to claim 1, wherein the sealed structure consists of a top portion and a bottom portion secured to each other by connection means.

3. The device according to claim 2, wherein the connection means are removable.

4. The device according to claim 2, wherein the body has two viewing windows facing each other, the top portion of said sealed structure has a viewing window facing a viewing window in said body, the bottom portion of said sealed structure has a viewing window facing the other viewing window in said body as well as a viewing window in the top portion.

5. The device according to claim 2, wherein the top portion of said sealed structure has a viewing window facing a viewing window that the body has, the bottom portion of said sealed structure not having a viewing window.

6. The device according to claim 2, wherein a gasket is disposed between said top and bottom portions.

7. The device according to claim 1, further comprising a pipe for putting the sealed chamber under vacuum, which is in fluid communication firstly with the inside of said sealed chamber and secondly with an outlet that is formed in the body and is designed to be connected to a vacuum-applying device.

8. The device according to claim 2, wherein either the bottom portion or the top portion of said sealed structure has at least one machining through which the pipe or pipes extend.

9. The device according to claim 1, wherein each pipe is a capillary tube, at least the part of which extending in the bottom portion or the top portion of said sealed structure is covered with a structure such as a stainless-steel tube.

10. A sealed structure designed to be disposed inside a device for synthesising and studying compounds under controlled temperatures and pressures as described in claim 1, wherein said sealed structure delimits a sealed chamber having one or more viewing windows facing each other, and at least one pipe that is in fluid communication firstly with the inside of said sealed chamber and secondly with an outlet leading out of said sealed structure.

11. The sealed structure according to claim 10, further comprising a top portion and a bottom portion secured to each other by connection means, either the bottom portion or the top portion of said sealed structure having a machining through which the pipe extends.
